(19) United States
(12) Patent Application Publication
(10) Pub. No.: US 2018/0229768 A1
(43) Pub. Date: Aug. 16, 2018

(54) ENHANCED LANE-KEEPING SYSTEM FOR AUTOMATED VEHICLES

(71) Applicant: Delphi Technologies, Inc., Troy, MI (US)

(72) Inventors: Liang Ma, Rochester Hills, MI (US); Michael I. Chia, Cicero, IN (US)

(21) Appl. No.: 15/454,196

(22) Filed: Mar. 9, 2017

Related U.S. Application Data
(60) Provisional application No. 62/458,218, filed on Feb. 13, 2017.

(51) Int. Cl. B62D 15/02; B62D 6/00; G05D 1/02

(52) U.S. Cl. CPC B62D 15/025; G05D 1/0246; B62D 6/001

(57) ABSTRACT

A lane-keeping-assist system suitable for use on an automated vehicle includes a camera, a steering-actuator, and a controller. The camera detects a lane-marking of a travel-lane traveled by a host-vehicle. The steering-actuator controls a travel-direction of the host-vehicle. The controller is in communication with the camera and the steering-actuator. The controller determines a lane-width of the travel-lane and determines a centerline of the travel-lane based on the lane-marking. The controller further determines an offset-position of the host-vehicle within the travel-lane based on the lane-marking. The controller further determines a clearance between the host-vehicle and the lane-marking based on the offset-position. The controller further determines an adaptive-threshold based on the lane-width. The controller further determines that the host-vehicle is approaching the lane-marking when the clearance is less than the adaptive-threshold, and activates the steering-actuator to steer the host-vehicle toward the centerline of the travel-lane.

### CROSS-REFERENCE TO RELATED APPLICATION

This application claims the benefit under 35 U.S.C. § 119(e) of U.S. Provisional Patent Application No. 62/458,218, filed Feb. 13, 2017, the entire disclosure of which is hereby incorporated herein by reference.

### TECHNICAL FIELD OF INVENTION

This disclosure generally relates to a lane-keeping system for an automated vehicle, and more particularly relates to using a threshold to determine an intervention timing.

### BACKGROUND OF INVENTION

It is known to apply a lane-keeping-assist (LKA) system to support autonomous driving. The typical LKA system automatically corrects an operator's lateral steering when a host-vehicle's position relative to a lane-marking is less than a predetermined constant-threshold.

### SUMMARY OF THE INVENTION

In accordance with one embodiment, a lane-keeping-assist system suitable for use on an automated vehicle is provided. The lane-keeping-assist system includes a camera, a steering-actuator, and a controller. The camera detects a lane-marking of a travel-lane traveled by a host-vehicle. The steering-actuator controls a travel-direction of the host-vehicle. The controller is in communication with the camera and the steering-actuator. The controller determines a lane-width of the travel-lane and determines a centerline of the travel-lane based on the lane-marking. The controller further determines an offset-position of the host-vehicle within the travel-lane based on the lane-marking. The controller further determines a clearance between the host-vehicle and the lane-marking based on the offset-position. The controller further determines an adaptive-threshold based on the lane-width. The controller further determines that the host-vehicle is approaching the lane-marking when the clearance is less than the adaptive-threshold, and activates the steering-actuator to steer the host-vehicle toward the centerline of the travel-lane.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a lane-keeping-assist system in accordance with one embodiment;

FIG. 2 is an illustration of a host-vehicle equipped with the lane-keeping-assist system of FIG. 1 in accordance with one embodiment;

FIG. 3 is a graph of an adaptive-threshold in accordance with one embodiment;

FIG. 4 is an illustration of a host-vehicle equipped with the lane-keeping-assist system of FIG. 1 in accordance with one embodiment;

FIG. 5 is a graph of an adaptive-threshold in accordance with one embodiment;

FIG. 6 is an illustration of a host-vehicle equipped with the lane-keeping-assist system of FIG. 1 in accordance with one embodiment;

FIG. 7A is an illustration of a host-vehicle equipped with the lane-keeping-assist system of FIG. 1 in accordance with one embodiment; and

FIG. 7B is an illustration of a host-vehicle equipped with the lane-keeping-assist system of FIG. 1 in accordance with one embodiment.

### DETAILED DESCRIPTION

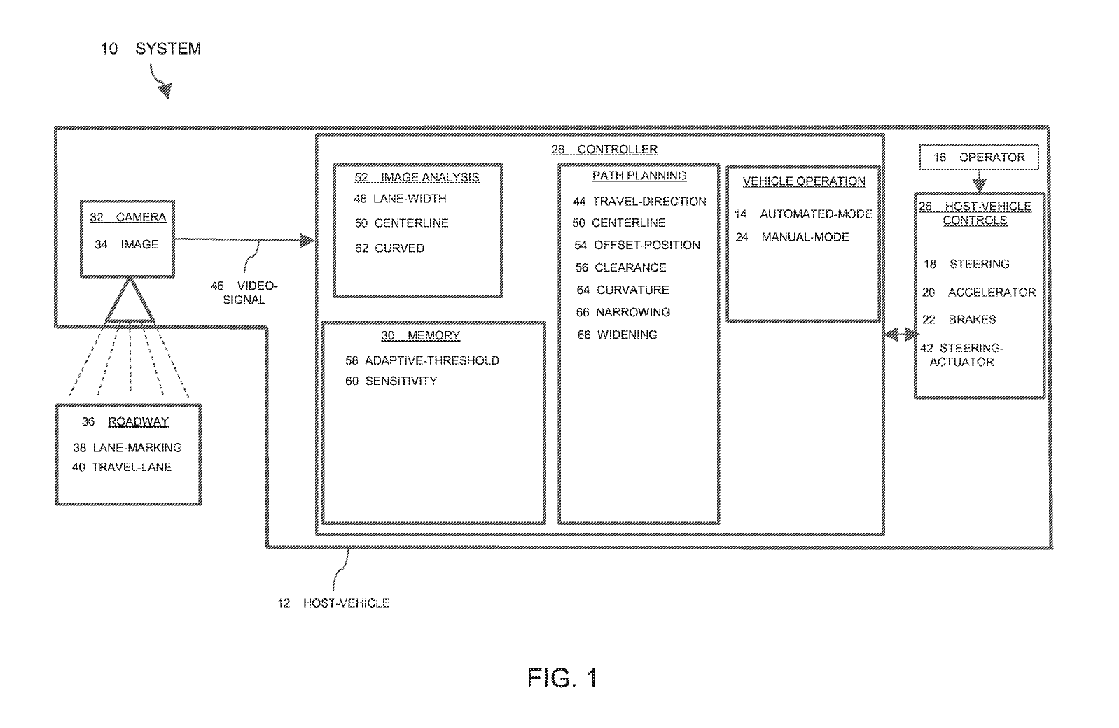

FIG. 1 illustrates a lane-keeping-assist system 10, hereafter referred to as the system 10, suitable for use on an automated vehicle, hereafter referred to as the host-vehicle 12. In general, the system 10 is configured to operate (i.e. drive) the host-vehicle 12 in an automated-mode 14 whereby an operator 16 of the host-vehicle 12 is little more than a passenger. That is, the operator 16 is not substantively involved with the steering 18 or operation of the accelerator 20 and brakes 22 of the host-vehicle 12. It is contemplated that the host-vehicle 12 may also be operated in a manual-mode 24 where the operator 16 is fully responsible for operating the host-vehicle-controls 26, or in a partial-mode (not shown) where control of the host-vehicle 12 is shared by the operator 16 and a controller 28 of the system 10.

The controller 28 may include a processor (not specifically shown) such as a microprocessor or other control circuitry such as analog and/or digital control circuitry including an application specific integrated circuit (ASIC) for processing data as should be evident to those in the art. The controller 28 may include a memory 30, including non-volatile memory, such as electrically erasable programmable read-only-memory (EEPROM) for storing one or more routines, thresholds, and captured data. The one or more routines may be executed by the processor to perform steps for operating the host-vehicle 12 based on signals received by the controller 28 as described herein.

The system 10 includes a camera 32 used to capture an image 34 of a roadway 36 traveled by the host-vehicle 12. Examples of the camera 32 suitable for use on the host-vehicle 12 are commercially available as will be recognized by those in the art, one such being the APTINA MT9V023 from Micron Technology, Inc. of Boise, Id., USA. The camera 32 may be mounted on the front of the host-vehicle 12, or mounted in the interior of the host-vehicle 12 at a location suitable for the camera 32 to view the area around the host-vehicle 12 through the windshield of the host-vehicle 12. The camera 32 is preferably a video-type camera 32 or camera 32 that can capture images of the roadway 36 and surrounding area at a sufficient frame-rate, of ten frames per second, for example.

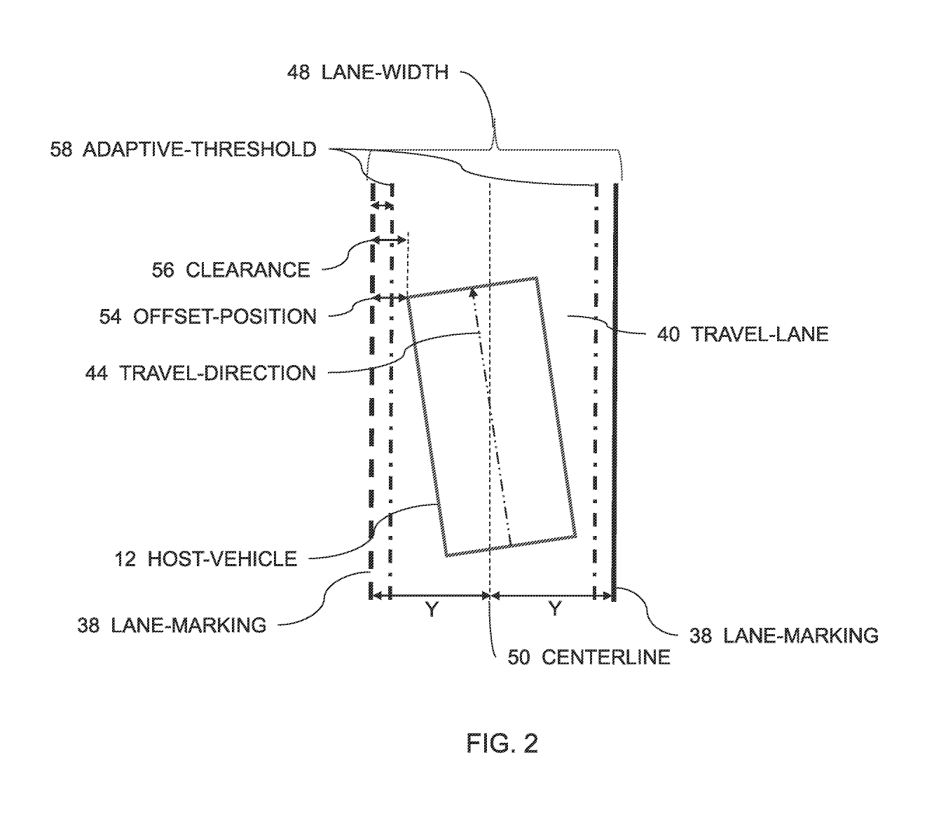

The image 34 may include, but is not limited to, a lane-marking 38 on a left-side and a right-side of a travel-lane 40 of the roadway 36 traveled by the host-vehicle 12 (see FIG. 2). The lane-marking 38 may include a solid-line, as is typically used to indicate a boundary of the travel-lane 40 of the roadway 36. The lane-marking 38 may also include a dashed-line, as is also typically used to indicate the boundary of the travel-lane 40 of the roadway 36.

The system 10 may also include a steering-actuator 42 (FIG. 1) that controls a travel-direction 44 of the host-vehicle 12. The steering-actuator 42 may be any steering-actuator 42 suitable for use in an automated vehicle, including, but not limited to, electric power steering, as will be recognized by one skilled in the art.

The controller 28 is in communication with the camera 32 so that the controller 28 may receive the image 34, via a video-signal 46, and determine both a lane-width 48 and a centerline 50 of the travel-lane 40 based on the lane-marking 38. That is, the image 34 detected or captured by the camera 32 is processed by the controller 28 using known techniques for image-analysis 52 to determine where along the roadway 36 the host-vehicle 12 should be operated or be steered when executing a lane-keeping maneuver. Vision processing technologies, such as the EYE Q® platform from Moblieye Vision Technologies, Ltd. of Jerusalem, Israel, or other suitable devices may be used. By way of example and not limitation, the centerline 50 is preferably in the middle of the travel-lane 40 traveled by the host-vehicle 12 (see FIG. 2).

FIG. 2 illustrates the host-vehicle 12 equipped with the system 10 traveling in the travel-lane 40. The controller 28 determines the lane-width 48 and the centerline 50 as described above. The controller 28 may also determine an offset-position 54 of the host-vehicle 12 within the travel-lane 40 based on the lane-marking 38. The offset-position 54 is shown on a left-side of the host-vehicle 12 for illustration purposes only, and may also be determined on a right-side of the host-vehicle 12. The controller 28 may then determine a clearance 56 between the host-vehicle 12 and the lane-marking 38 based on the offset-position 54. The clearance 56 is shown on the left-side of the host-vehicle 12 for illustration purposes only, and may also be determined on the right-side of the host-vehicle 12.

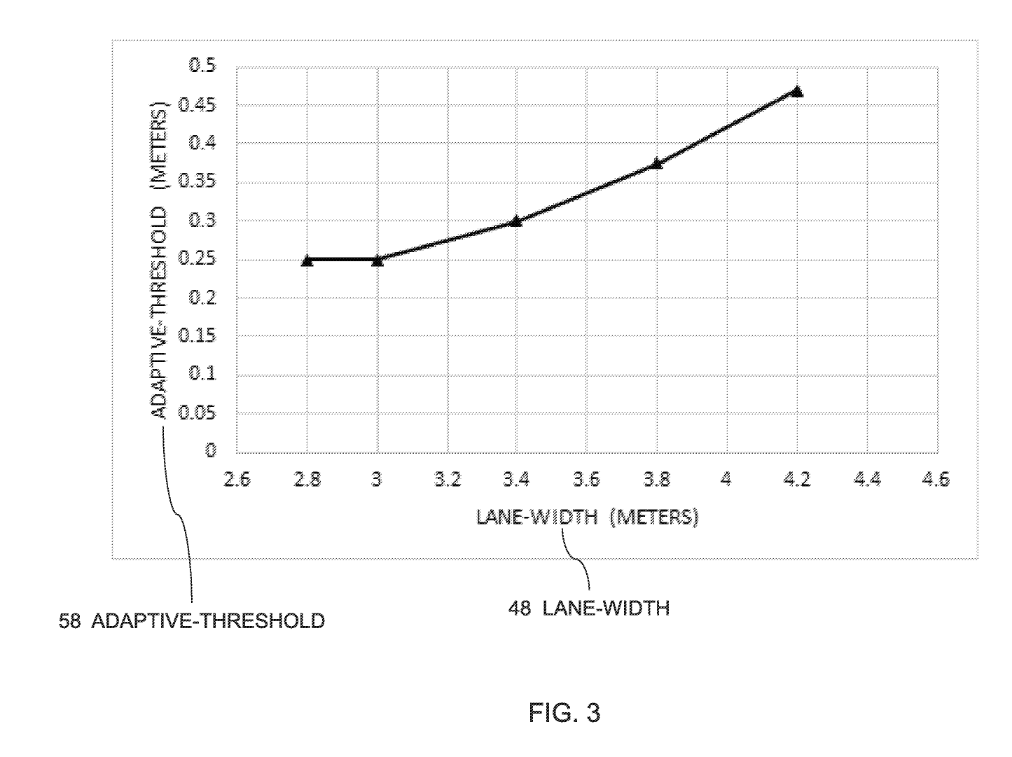

The controller 28 may also determine an adaptive-threshold 58 as illustrated in FIG. 2. The adaptive-threshold 58 defines a bi-lateral boundary (i.e. applied to both sides of the host-vehicle 12) within the travel-lane 40 beyond which the host-vehicle 12 is determined by the controller 28 to be at risk of unintentionally exiting the travel-lane 40. The adaptive-threshold 58 may be based on the lane-width 48 as illustrated in FIG. 3. The adaptive-threshold 58 may increase with an increasing value of the lane-width 48, which is beneficial compared to the prior art fixed-threshold (not shown) because it may reduce the frequency of automated steering-interventions when the host-vehicle 12 is operated in a relatively narrow instance of the travel-lane 40 (due to a smaller lateral-offset-distance to the centerline 50), and may reduce the magnitude of the automated steering-interventions when the host-vehicle 12 is operated in a relatively wide instance of the travel-lane 40 (due to a larger lateral-offset-distance to the centerline 50). The above benefits of the adaptive-threshold 58 will help to discourage the operator 16 of the host-vehicle 12 from disabling the system 10.

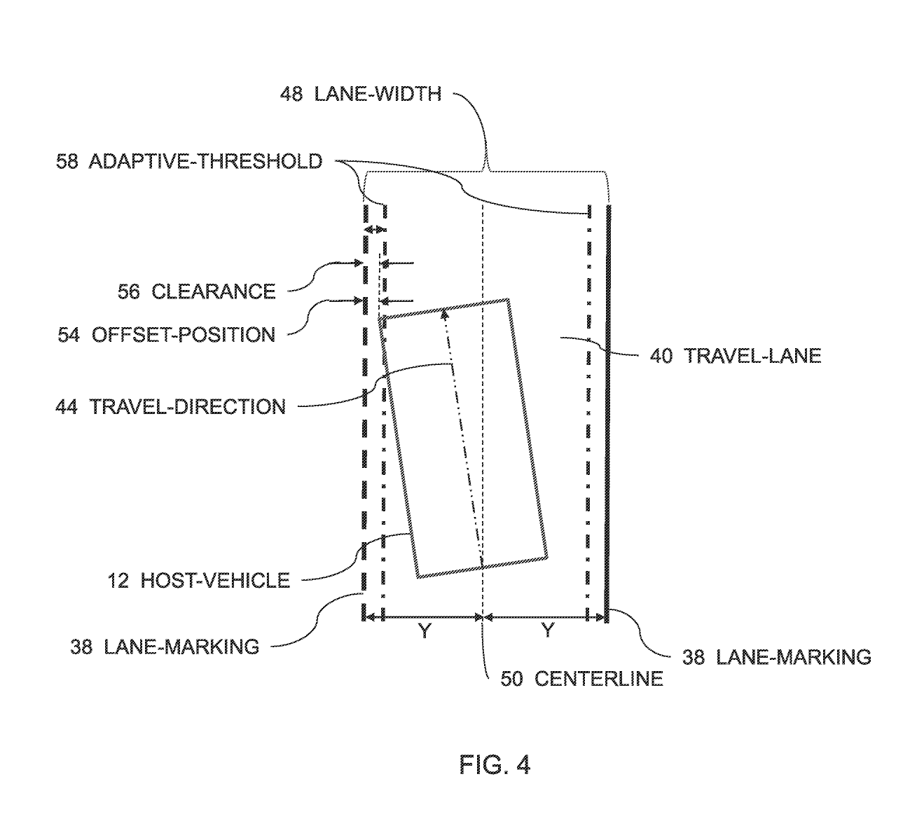

FIG. 4 illustrates the controller 28 determining that the host-vehicle 12 is approaching the lane-marking 38 when the clearance 56 is less than the adaptive-threshold 58. The controller 28 may then activate the steering-actuator 42 to steer the host-vehicle 12 toward the centerline 50 of the travel-lane 40. The host-vehicle 12 is shown approaching the left-side of the travel-lane 40 for illustration purposes only. The controller 28 may also activate the steering-actuator 42 to steer the host-vehicle 12 toward the centerline 50 of the travel-lane 40 when the host-vehicle 12 is approaching the lane-marking 38 on the right-side of the travel-lane 40. The controller 28 may not activate the steering-actuator 42 when a turn-signal indicates the host-vehicle 12 is performing a particular maneuver, such as a lane-change or a turn.

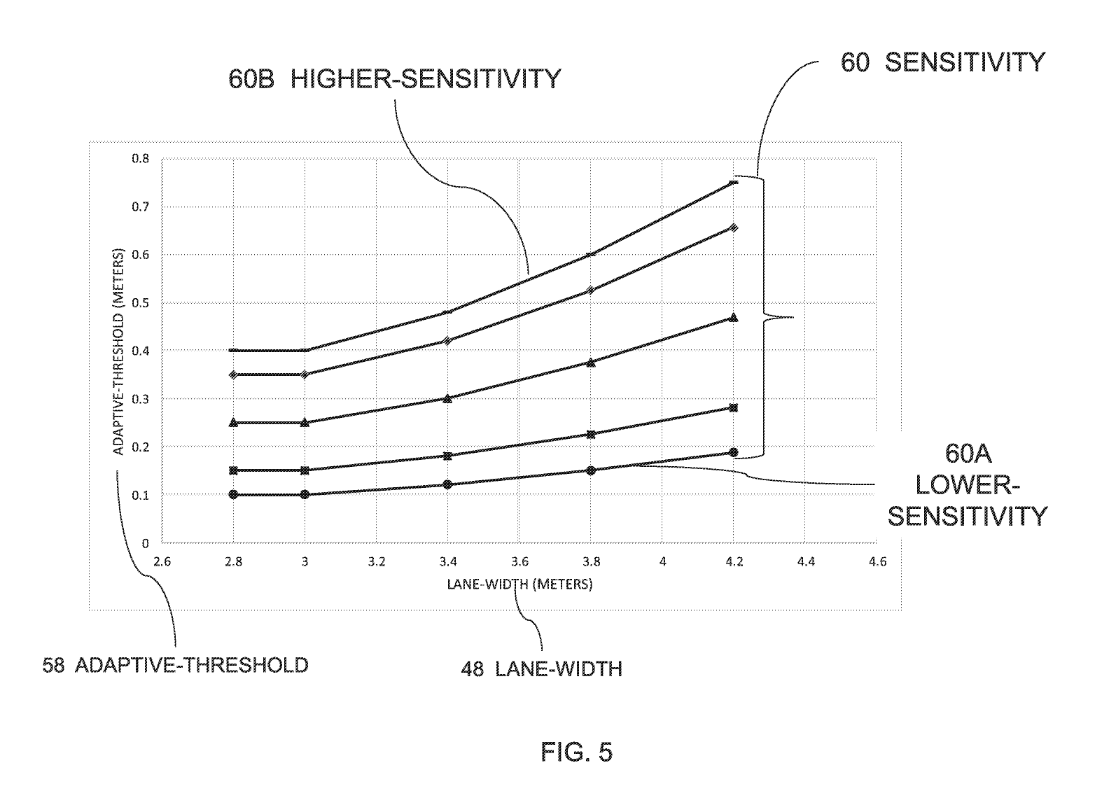

The operator 16 of the host-vehicle 12 may select a sensitivity 60 of the adaptive-threshold 58 based on a preference of the operator 16, and the controller 28 may further adjust the adaptive-threshold 58 based on the selected value of the sensitivity 60. FIG. 5 illustrates how the adaptive-threshold 58 may be adjusted based on the selected value of the sensitivity 60 for various values of the lane-width 48. The plot of FIG. 5 includes lines indicative of constant values of the sensitivity 60 which illustrate the relationship between the lane-width 48 and the adaptive-threshold 58. An operator 16 may select a lower-sensitivity 60A, as illustrated by the bottom-line in the plot, which acts to reduce the spacing between the adaptive-threshold 58 and the lane-marking 38, decreasing the likelihood of automated steering-interventions. An operator 16 may also select a higher-sensitivity 60B, as illustrated by the top-line in the plot, which acts to increase the spacing between the adaptive-threshold 58 and the lane-marking 38, increasing the likelihood of automated steering-interventions.

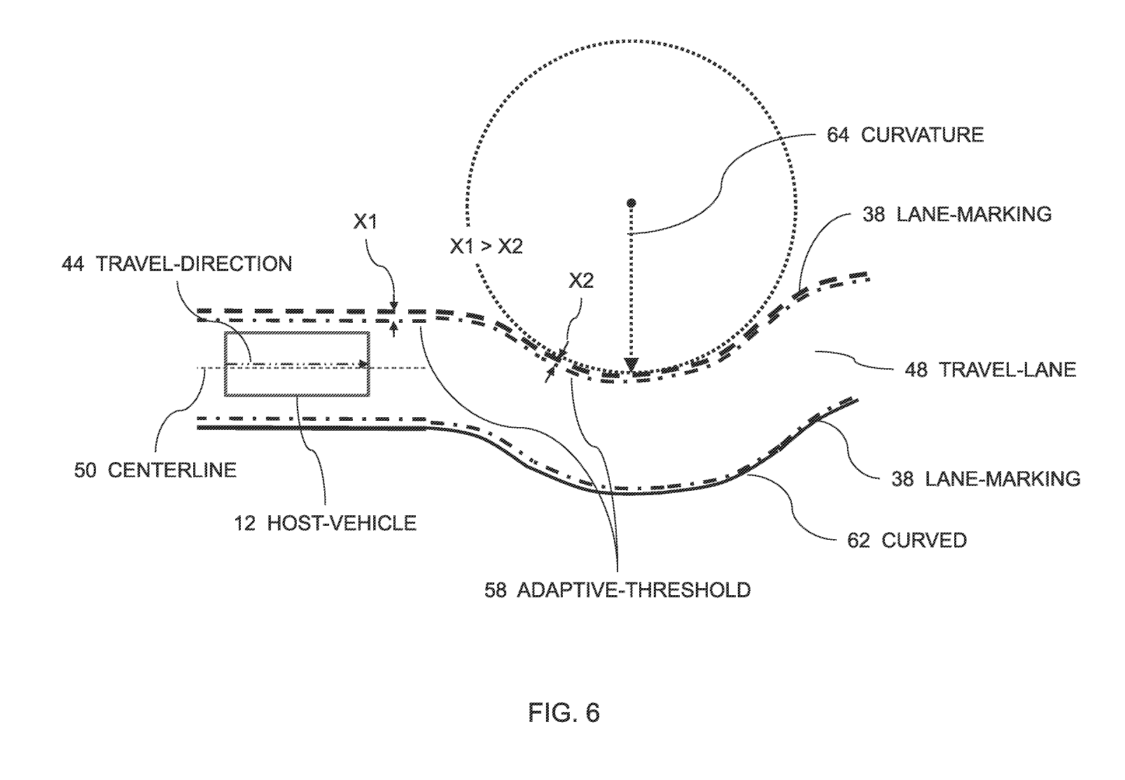

The controller 28 may further determine that the travel-lane 40 is curved 62 based on the lane-marking 38 and may adjust the adaptive-threshold 58 based on a curvature 64 of the lane-marking 38 (see FIG. 6). The controller 28 may further reduce the adaptive-threshold 58 by a predefined dimension (e.g. 0.15 meters) to further reduce the likelihood of automated steering-interventions, which may become an annoyance to the operator 16 traveling on a curved 62 roadway 36. The controller 28 may also skew (not shown) the adaptive-threshold 58 to be reduced at an inside-radius of the curve of the travel-lane 40 and increase the adaptive-threshold 58 at an outside-radius of the curve of the travel-lane 40.

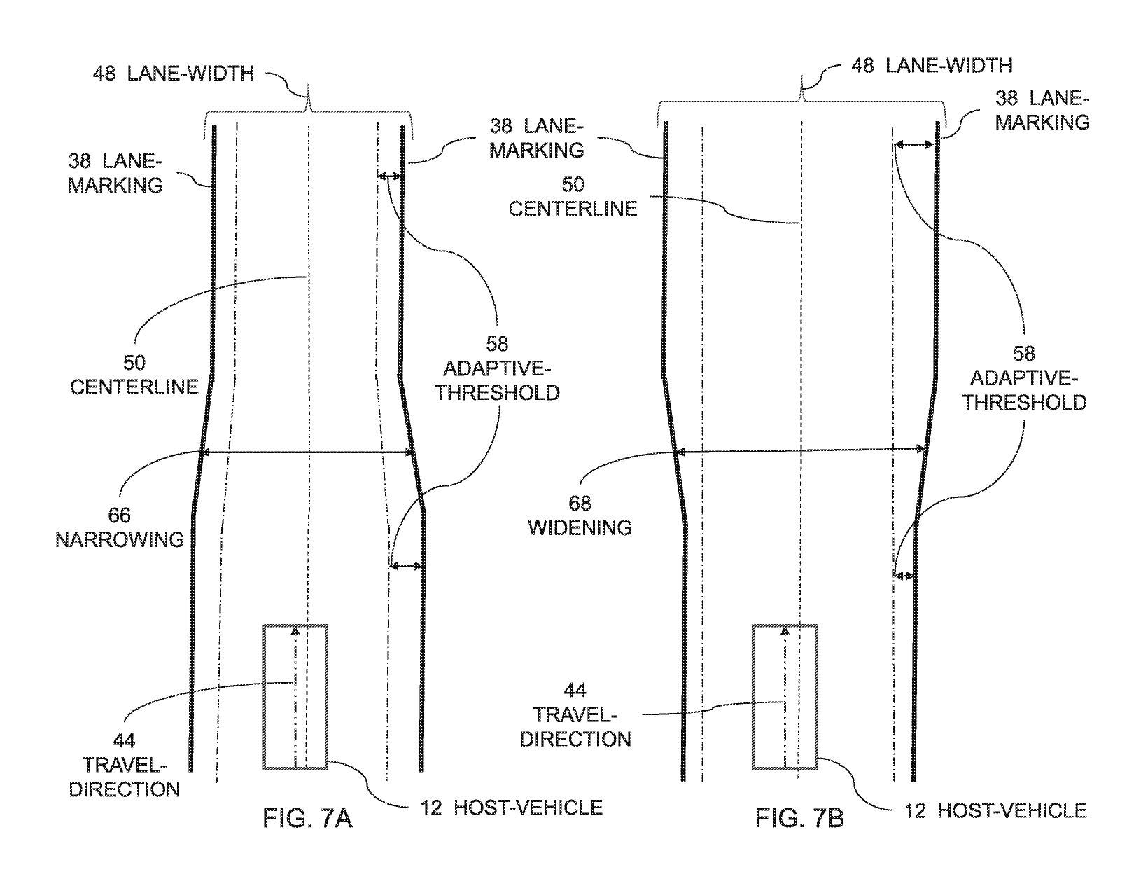

The controller 28 may further determine that the lane-width 48 is narrowing 66 based on the lane-marking 38 and may decrease the adaptive-threshold 58 by a predefined dimension (see FIG. 7A), and may further determine that the lane-width 48 is widening 68 and may increase the adaptive-threshold 58 by a predefined dimension (see FIG. 7B). The amount of reduction and/or increase of the adaptive-threshold 58 may be defined by the user and may vary with the lane-width 48.

The adaptive-threshold 58 and sensitivity 60 may be stored in the memory 30 of the controller 28 as a two-dimensional look-up table and the controller 28 may calculate the adaptive-threshold 58 for any lane-width 48 using the look-up table with linear-interpolation.

Accordingly, a lane-keeping-assist system 10, and a controller 28 for the lane-keeping-assist system 10 is provided. The adaptive-threshold 58 is beneficial compared to the prior art fixed-threshold because it may reduce the frequency of automated steering-interventions when the host-vehicle 12 is operated in a narrow instance of the travel-lane 40, and may reduce the magnitude of the automated steering-interventions when the host-vehicle 12 is operated in a wide instance of the travel-lane 40. The above benefits of the adaptive-threshold 58 will help to discourage the operator 16 of the host-vehicle 12 from disabling the lane-keeping-assist system 10.

While this invention has been described in terms of the preferred embodiments thereof, it is not intended to be so limited, but rather only to the extent set forth in the claims that follow. Moreover, the use of the terms first, second, upper, lower, etc. does not denote any order of importance, location, or orientation, but rather the terms first, second, etc. are used to distinguish one element from another. Furthermore, the use of the terms a, an, etc. do not denote a limitation of quantity, but rather denote the presence of at least one of the referenced items.

We claim:

1. A lane-keeping-assist system suitable for use on an automated vehicle, said system comprising:
a camera that detects a lane-marking of a travel-lane traveled by a host-vehicle;
a steering-actuator that controls a travel-direction of the host-vehicle; and
a controller in communication with the camera and the steering-actuator, said controller determines a lane-width of the travel-lane and a centerline of the travel-lane based on the lane-marking, determines an offset-position of the host-vehicle within the travel-lane based on the lane-marking, determines a clearance between the host-vehicle and the lane-marking based on the offset-position, determines an adaptive-threshold based on the lane-width, determines that the host-vehicle is approaching the lane-marking when the clearance is less than the adaptive-threshold, and activates the steering-actuator to steer the host-vehicle toward the centerline of the travel-lane.

2. The system in accordance with claim 1, wherein an operator of the host-vehicle selects a sensitivity based on a preference of the operator, and the controller further adjusts the adaptive-threshold based on the sensitivity.

3. The system in accordance with claim 1, wherein the controller further determines that the travel-lane is curved based on the lane-marking and adjusts the adaptive-threshold based on a curvature of the lane-marking.

4. The system in accordance with claim 3, wherein the adaptive-threshold is reduced by a predefined dimension.

5. The system in accordance with claim 1, wherein the controller further determines that the lane-width is narrowing and decreases the adaptive-threshold by a predefined dimension.

6. The system in accordance with claim 1, wherein the controller further determines that the lane-width is widening and increases the adaptive-threshold by a predefined dimension.
